(19) United States
(12) Patent Application Publication
(10) Pub. No.: US 2025/0116991 A1
(43) Pub. Date: Apr. 10, 2025

(54) SYSTEM AND METHOD FOR CONTROLLING OPERATING CONDITIONS OF ELECTROLYZER UNITS

(71) Applicant: ACWA POWER Company, Riyadh (SA)

(72) Inventor: Amit Kumar BERIYA, Dubai (AE)

(73) Assignee: ACWA POWER Company, Riyadh (SA)

(21) Appl. No.: 18/906,729

(22) Filed: Oct. 4, 2024

Related U.S. Application Data
(60) Provisional application No. 63/587,898, filed on Oct. 4, 2023.

(51) Int. Cl. G05B 19/4155

(52) U.S. Cl. CPC G05B 19/4155; G05B 2219/32287

(57) ABSTRACT

A system and method for controlling the operating conditions of an electrolyzer unit receives input data associated with that unit from databases. The system applies a machine learning model on the input data and predicts an operating load condition of the electrolyzer unit for a first time period. The system also determines an operating temperature range for the electrolyzer unit for the first time period based on the operating load condition. The system determines the flow rate of a coolant from a cooling unit to the electrolyzer unit based on the determined operating temperature range and the predicted operating load condition. The system controls the cooling unit to modify the flow rate of the coolant to the electrolyzer unit based on the determined flow rate of the coolant to maintain the determined operating temperature range.

### CROSS-REFERENCE TO RELATED APPLICATION

This application claims priority to U.S. Provisional Patent Application Ser. No. 63/587,898, filed Oct. 4, 2023 and entitled SYSTEM AND METHOD FOR CONTROLLING OPERATING CONDITIONS OF ELECTROLYZER UNITS, the disclosure of which is incorporated herein by reference.

### TECHNOLOGICAL FIELD

The present disclosure generally relates to electrolyzer units for producing hydrogen gas, and more particularly relates to systems and methods for controlling the operating conditions of the electrolyzer units.

### BACKGROUND

An electrolyzer unit is a device that uses electricity to induce a chemical reaction called electrolysis. The primary purpose of an electrolyzer is to split an electrolyte into its constituent elements. Specifically, electrolysis occurs when an electric current passes through the electrolyte, causing the molecules of the electrolyte to dissociate into ions of its constituent elements. For example, when an electric current passes through water (H₂O), the molecules of water may dissociate into hydrogen ions (H⁺) and hydroxide ions (OH⁻) at the cathode and anode, respectively. To this end, the hydrogen ions and hydroxide ions further react to form hydrogen gas (H₂) at the cathode and oxygen gas (O₂) at the anode, thereby splitting the water molecules into their constituent elements. For example, the produced hydrogen gas may be used in various applications, such as fuel for hydrogen fuel cells, industrial processes, and as an energy storage medium.

Typically, the water electrolyzer (i.e. devices that use electricity to split water (H₂O) into its constituent elements hydrogen (H₂) and oxygen (O₂)) is used with a constant power source that may be supplied from a power grid. However, with the climate change impact and increased utility of hydrogen produced from the electrolyzer, renewable and clean power sources are being used increasingly to power the electrolyzer. For example, renewable energy-based power sources may include, but are not limited to, solar energy-based power sources, and wind energy-based power sources. However, these renewable power sources are inherently intermittent (i.e. these renewable power sources do not produce a constant and predictable supply of electricity). As a result, renewable power sources cannot be relied upon to provide a stable power supply.

In certain cases, energy storage mediums may be used to store excess energy produced during peak cycles. However, the inclusion of such large energy storage mediums may lead to an increase in infrastructure cost, thereby increasing the cost of power produced. As a result, the cost of hydrogen produced using such renewable energy-powered electrolyzer may be substantially high. Accordingly, there is a need to address the drawbacks associated with electrolyzers that are supplied by renewable power sources.

### BRIEF SUMMARY

The present invention discloses a system, and a method is provided herein that focuses on controlling the operating conditions of the electrolyzer to control the rate of exchange of heat produced during the production of hydrogen, thereby optimizing the production of hydrogen.

In one aspect, a system for controlling the operating conditions of an electrolyzer is disclosed. The system includes at least one processor and a memory coupled to the processor, the memory having stored therein at least one of programs or instructions executable by the processor to configure the system to receive input data associated with an electrolyzer unit from one or more databases. The processor is further configured to apply a Machine Learning (ML) model on the received input data. The processor is further configured to predict, using the ML model on the received input data, an operating load condition of the electrolyzer unit for a first time period of a set of time periods. The processor is further configured to determine an operating temperature range for the electrolyzer unit for the first time period of the set of time periods based on the predicted operating load condition of the electrolyzer unit for the first time period. The processor is further configured to determine a flow rate of a coolant from a cooling unit to the electrolyzer unit based on the determined operating temperature range for the electrolyzer unit and the predicted operating load condition for the first time period. Based on the determined flow rate of the coolant, the processor is configured to control the cooling unit to modify the flow rate of the coolant from the cooling unit to the electrolyzer unit to maintain the determined operating temperature range of the electrolyzer unit for the predicted operating load condition.

In additional system embodiments, the received input data includes at least one of weather forecast data, power generation forecast data, ambient air temperature value data, and ambient wind speed forecast data.

In additional system embodiments, the operating load condition for the first time period of the set of time periods corresponds to one of a part load condition, a full load condition, or an overload condition.

In additional system embodiments, the processor is further configured to execute the computer-executable instructions to determine the first time period of the set of time periods based on at least a pre-defined time duration or a change in weather conditions.

In additional system embodiments, the determined operating temperature range includes an upper temperature value and a lower temperature value. The upper temperature value corresponds to a maximum operating temperature value associated with the operating load condition of the electrolyzer unit and the lower temperature value corresponds to a minimum operating temperature value associated with the operating load condition of the electrolyzer unit.

In additional system embodiments, the processor is further configured to execute the computer-executable instructions to receive the upper temperature value and the lower temperature value associated with the determined operating temperature range for the operating load condition and store the received upper temperature value and the received lower temperature value in the memory.

In additional system embodiments, the processor is further configured to execute the computer-executable instructions to apply the ML model on the received input data to determine the upper temperature value and the lower temperature value associated with the determined operating temperature range for the corresponding operating load condition.

In another aspect, a method for controlling the operating conditions of an electrolyzer is disclosed. The method includes receiving input data associated with an electrolyzer unit from one or more databases. The method further includes applying a machine learning (ML) model on the received input data. The method further includes predicting, based on the application of the ML model on the received input data, an operating load condition of the electrolyzer unit for the first time period of a set of time periods. The method further includes determining an operating temperature range for the electrolyzer unit for the first time period of the set of time periods based on the predicted operating load condition of the electrolyzer unit for the first time period. The method further includes determining a flow rate of a coolant from a cooling unit to the electrolyzer unit based on the determined operating temperature range for the electrolyzer unit and the predicted operating load condition for the first time period. The method further includes controlling the cooling unit to modify the flow rate of the coolant from the cooling unit to the electrolyzer unit based on the determined flow rate of the coolant to maintain the determined operating temperature range of the electrolyzer unit for the predicted operating load condition.

In additional method embodiments, the received input data includes at least one of weather forecast data, power generation forecast data, ambient air temperature value data, and ambient wind speed forecast data.

In additional method embodiments, the operating load condition for the first time period of the set of time periods corresponds to one of a part load condition, a full load condition, or an overload condition.

In additional method embodiments, the method further includes determining the first time period of the set of time periods based on at least a pre-defined time duration or a change in weather conditions.

In additional method embodiments, the determined operating temperature range includes an upper temperature value and a lower temperature value. The upper temperature value corresponds to a maximum operating temperature value associated with the operating load condition of the electrolyzer unit and the lower temperature value corresponds to a minimum operating temperature value associated with the operating load condition of the electrolyzer unit.

In additional method embodiments, the method further includes receiving the upper temperature value and the lower temperature value associated with the determined operating temperature range for the operating load condition and storing the received upper temperature value and the received lower temperature value.

In additional method embodiments, the method further includes applying the ML model on the received input data to determine the upper temperature value and the lower temperature value associated with the determined operating temperature range for the corresponding operating load condition.

In yet another aspect, a non-transitory computer-readable medium having stored thereon, computer-executable instructions that when executed by a processor of a system, causes the processor to execute operations including receiving input data associated with an electrolyzer unit from one or more databases. The operations further include applying a machine learning (ML) model on the received input data. The operations further include predicting, based on the application of the ML model on the received input data, an operating load condition of the electrolyzer unit for the first time period of a set of time periods. The operations further include determining an operating temperature range for the electrolyzer unit for the first time period of the set of time periods based on the predicted operating load condition of the electrolyzer unit for the first time period. The operations further include determining a flow rate of a coolant from a cooling unit to the electrolyzer unit based on the determined operating temperature range for the electrolyzer unit and the predicted operating load condition for the first time period. The operations further include controlling the cooling unit to modify the flow rate of the coolant from the cooling unit to the electrolyzer unit based on the determined flow rate of the coolant to maintain the determined operating temperature range of the electrolyzer unit for the predicted operating load condition.

In additional computer program product embodiments, the received input data includes at least one of weather forecast data, power generation forecast data, ambient air temperature value data, and ambient wind speed forecast data.

In additional computer program product embodiments, the operating load condition for the first time period of the set of time periods corresponds to one of a part load condition, a full load condition, or an overload condition.

In additional computer program product embodiments, the determined operating temperature range includes an upper temperature value and a lower temperature value. The upper temperature value corresponds to a maximum operating temperature value associated with the operating load condition of the electrolyzer unit and the lower temperature value corresponds to a minimum operating temperature value associated with the operating load condition of the electrolyzer unit.

In additional computer program product embodiments, the operations further include receiving the upper temperature value and the lower temperature value associated with the determined operating temperature range for the operating load condition and storing the received upper temperature value and the received lower temperature value.

In additional computer program product embodiments, the operations further include applying the ML model on the received input data to determine the upper temperature value and the lower temperature value associated with the determined operating temperature range for the corresponding operating load condition.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 shows a network environment in which a system for controlling the operating conditions of an electrolyzer unit is implemented, in accordance with an embodiment of the present disclosure;

FIG. 2 illustrates a block diagram of the apparatus of FIG. 1, in accordance with an embodiment of the present disclosure;

FIG. 3 is a block diagram that illustrates an exemplary first set of operations for controlling the operating conditions of the electrolyzer unit, in accordance with an embodiment of the present disclosure;

FIG. 4 is a block diagram that illustrates an exemplary second set of operations for controlling the operating conditions of the electrolyzer, in accordance with an embodiment of the present disclosure;

FIG. 5 illustrates an exemplary schematic diagram for performing predictions related to the electrolyzer using a machine learning model, in accordance with an embodiment of the present disclosure; and

FIG. 6 illustrates a flowchart for the implementation of an exemplary method for controlling the operating condition of the electrolyzer unit using the machine learning model, in accordance with an embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity but rather denote the presence of at least one of the referenced items. Moreover, various features are described which may be exhibited by some embodiments and not by others. Similarly, various requirements are described which may be requirements for some embodiments but not for other embodiments.

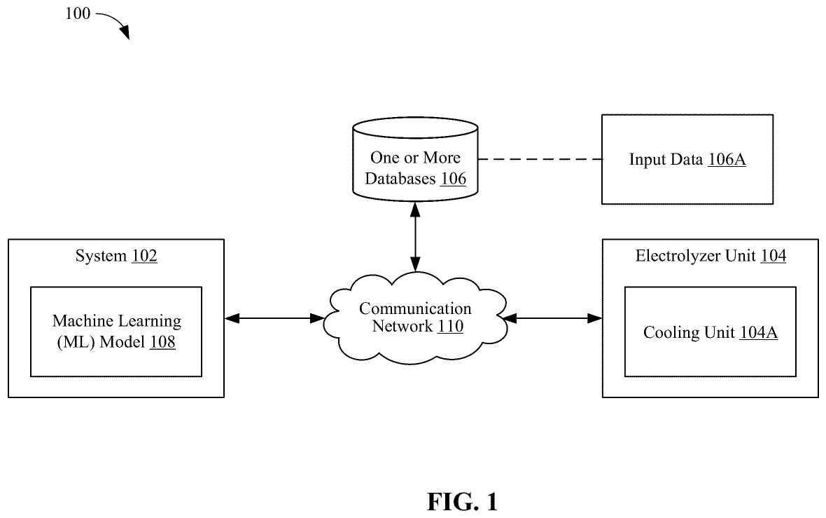

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 6, a brief description concerning the various components of the present disclosure will now be briefly discussed. Reference will be made to the figures showing various embodiments of a system for controlling the operating conditions of an electrolyzer unit.

FIG. 1 illustrates a network environment in which a system for controlling the operating conditions of an electrolyzer unit is implemented, in accordance with an embodiment of the present disclosure. With reference to FIG. 1, there is shown a network environment 100. The network environment 100 may include a system 102, an electrolyzer unit 104, one or more databases 106, a machine learning (ML) model 108, and a communication network 110.

The system 102 may correspond to a machine learning-based system that may have the capability to control the operating conditions of the electrolyzer unit 104, thereby optimizing the production of hydrogen. The system 102 may control the operating conditions of the electrolyzer unit 104 by controlling the rate of exchange of heat produced during the process of hydrogen generation. For example, the system 102 may correspond to a simulation system for simulating the operation of the electrolyzer unit 104. For example, the system 102 may correspond to a computer-executable algorithm to achieve one or more functions of the machine learning-based system for controlling the operating conditions of the electrolyzer unit 104.

The system 102 may further include the ML model 108. The system 102 may be further configured to provide, as an input, input data 106A to the ML model 108. The ML model 108 may be a prediction model that may be trained to identify a relationship between inputs, (such as input data 106A in a training dataset that may include a dataset of the plurality of parameters) and output prediction indicative of the operating load condition. The ML model 108 may be defined by its hyper-parameters, for example, the number of weights, cost function, input size, number of layers, and the like. The hyper-parameters of the ML model 108 may be tuned and weights may be updated to move towards a global minimum of a cost function for the ML model 108. After several epochs of training on the feature information in the training dataset, the neural network model may be trained to generate the ML model 108 and subsequently output a classification result for a set of inputs.

The ML model 108 may include electronic data, such as, for example, a software program, code of the software program, libraries, applications, scripts, or other logic or instructions for execution by a processing device, such as circuitry. The ML model 108 may be implemented using hardware including a processor, a microprocessor (e.g., to perform or control the performance of one or more operations), a field-programmable gate array (FPGA), or an application-specific integrated circuit (ASIC). Alternatively, in some embodiments, the ML model 108 may be implemented using a combination of hardware and software. Although in FIG. 1, the ML model 108 is shown integrated within the system 102, the disclosure is not so limited. Accordingly, in some embodiments, the ML model 108 may be a separate entity in the system 102, without deviation from the scope of the disclosure. Examples of the ML model 108 may include but are not limited to, an artificial neural network (ANN), a convolutional neural network (CNN), a deep neural network (DNN), a fully connected neural network, and/or a combination of such networks.

For example, the ML model 108 may correspond to a machine learning and reduced-order physics-based model. This may facilitate providing a simplified mathematical model that captures the essential behavior of a complex physical system while reducing computational cost. Further, such a model may be derived from a high fidelity, full-order model, typically based on fundamental principles of physics for example, but not limited to conservation laws, thermodynamics, and fluid mechanics. By leveraging machine learning alongside reduced-order physics-based models, the system 102 may predict the operating load conditions and determine the operating temperature associated therewith, efficiently and accurately,

The one or more databases 106 may be a specialized machine that may be designed to store and manage the input data 106A within the network environment 100. The one or more databases 106 may play a crucial role in responding to the system 102 request, processing data, and delivering the data efficiently. The one or more databases 106 may be designed for high-performance computing and data handling, ensuring that the system 102 requests may be handled accordingly and that the requested content is delivered to the system 102 seamlessly. For example, the system 102 may request, process, and deliver the input data 106A from the one or more databases 106 to the ML model 108. The input data 106A may correspond to real-time parameters associated with the operating conditions of the electrolyzer unit 104.

Further, the electrolyzer unit 104 may use electrolysis for the production of hydrogen from renewable resources. The electrolysis may be a process that uses electricity to split water into hydrogen and oxygen at an electrolyzing temperature value. The electrolyzing temperature value may be the temperature value at which a molecule of water (H₂O) may be broken into one hydrogen (H₂) molecule and one oxygen atom. For example, the electrolyzing temperature value for the water is 85 degrees Celsius.

In operation, the electrolyzer unit 104 may receive the water and an electric current may be passed through the water to initiate different reactions (e.g., an oxidation reaction and/or a reduction reaction) at different electrodes (e.g., an anode and/or a cathode) of the electrolyzer unit 104. For example, at the anode, the oxidation reaction may take place causing the electrolyzer unit 104 to produce oxygen. Further, at the cathode, the reduction reaction may take place causing the electrolyzer unit 104 to produce hydrogen (H₂) in a gaseous form. The hydrogen generated during electrolysis may be collected separately from the oxygen. Since hydrogen gas is lighter than the air, it can be collected by displacement or through a gas-collecting apparatus. The electrolyzer unit 104 functions in different ways, mainly due to the different types of electrolyte material involved and the ionic species it conducts.

For example, the process of the hydrogen production within the electrolyzer unit 104 results in the generation of heat. Such generated heat may be typically managed through heat removal mechanisms, encompassing a flow of cooling fluid and the convective exchange with ambient air. Further, the electrolyzer unit 104 may be powered by renewable energy-based power sources, i.e., the electric current applied across the two electrodes is generated using renewable energy-based power sources. Examples of renewable energy-based power sources may include, but are not limited to, solar energy-based power sources, and wind energy-based power sources. However, these renewable energy-based power sources are intermittent and may fail to provide a stable power supply to the electrolyzer unit 104. Moreover, the integration of energy storage devices, such as batteries, has limitations, such as increased set-up cost, increased maintenance cost, and therefore, increased cost of hydrogen generated by the electrolyzer unit 104. The electrolyzer unit 104 may be further supplied from renewable energy-based power sources, such as solar or Photovoltaic (PV) sources, or wind sources. In such a case, the electrolyzer unit 104 may experience a full load condition, a part load condition, and/or an overload condition.

During the full load and the overload conditions, the power supply received from the renewable energy-based power source may be equal to or greater than the demand or required power of the electrolyzer unit 104. Conventionally, for maintaining temperature value at overload conditions, a cooling unit 104A may have to be over-sized, which may require higher capital expenditure. The cooling unit 104A may correspond to a component of the electrolyzer unit 104 that may be designed to maintain the temperature value of the electrolyzer unit 104 using a coolant.

To overcome the problem associated with the use of an over-sized cooling unit 104A, the system 102 may facilitate a reduction of the temperature value of the electrolyzer unit 104 in a current time period. For example, when the heat generation is higher due to the overload condition in a succeeding time period, the cooling unit 104A may facilitate maintaining the temperature value of the electrolyzer unit 104 by modifying the flow rate of the coolant. Further, in such an example, the temperature value of the electrolyzer unit 104 may be reduced in the present time period, while maintaining an operating temperature value of the electrolyzer within an operating temperature range. The operating temperature value may be maintained in the present time period for the future time period, therefore the over-sized cooling unit 104A may not be required. Such a reduction in the size of the cooling unit 104A may lead to a reduced capital expenditure.

However, during the part load condition, the power supply received from the renewable energy-based power source may be less than the demand or required power of the electrolyzer unit 104. As the power supply does not meet the demand power required by the electrolyzer unit 104, the electrolyzer unit 104 may not be able to maintain the operating temperature value within the operating temperature range. In particular, while heat generation within the electrolyzer unit 104 may decrease, the heat removal process in the electrolyzer unit 104 may be conducted due to the flow rate of the coolant as well as due to natural convection to ambient air. The flow rate of the coolant may be controlled to maintain the operating temperature value within the operating temperature range.

The efficiency and performance of the electrolyzer unit 104 may be impacted based on the operating temperature value of the electrolyzer unit 104. It may be understood that maintaining an elevated operating temperature value within a specified range, i.e., within the optimum operating temperature range, may improve the performance of the electrolyzer unit 104. For example, as the operating temperature value increases, the efficiency of the electrolysis process tends to improve as a higher temperature value may lead to lower electrical resistance in the electrolyte solution, resulting in better ion mobility and faster reaction kinetics for the full load or the overload, i.e., higher hydrogen and oxygen production rates.

Therefore, during the part load condition, the efficiency of the electrolyzer unit 104 may be affected adversely. Moreover, due to the reduced operating temperature value during part load, in some cases, the efficiency of the electrolyzer unit 104 may also be affected during the full load condition that may occur after such a part load condition. For example, as the operating temperature value reduces substantially during the part load condition, such operating temperature value may not be scaled or increased appropriately or quickly in the next full load. Therefore, during a time in which the operating temperature value is still increasing, the electrolyzer unit 104 may still operate at reduced efficiency. Further, in cases of high fluctuations between full load and part load conditions of the electrolyzer unit 104, the efficiency of the electrolyzer unit 104 may not be maintained reliably.

In some cases, the temperature value reduction during the part load condition may be facilitated by incorporating heaters within the electrolyzer unit 104. However, this approach may introduce additional power consumption, thereby undermining potential enhancements in hydrogen production attributed to the use of clean and sustainable renewable energy-based power sources. Furthermore, the integration of heaters raises capital expenditure and maintenance costs.

To this end, embodiments of the present disclosure may provide a solution to the aforementioned problem associated with unstable power supply from renewable energy-based power sources. For example, the embodiments of the present disclosure pertain to controlling the operating load condition of the electrolyzer unit 104 to maintain the operating temperature value of the electrolyzer unit 104 within the operating temperature range. Further, the embodiments of the present disclosure ensure efficient operation of the electrolyzer unit 104 without using any additional energy storage devices, thereby reducing capital expenditure and maintenance costs associated with the electrolyzer unit 104.

Further, the machine learning (ML) model 108 may be configured to predict the operating load condition to be experienced by the electrolyzer unit 104, for the first time period of a set of time periods. Based on such prediction of the operating load condition to be experienced by the electrolyzer unit 104, the operating load condition of the electrolyzer unit 104 may be controlled in a feed-forward manner to maintain the operating temperature value within the operating temperature range thereby improving the performance of the electrolyzer unit 104. The feed-forward manner may be a control strategy that may involve using data from load sensors to predict and counteract changes in the process before they occur.

In operation, the system 102 may be configured to receive input data 106A associated with the electrolyzer unit 104 from one or more databases 106. For example, the input data 106A may include but is not limited to, weather forecast data, power generation forecast data, ambient air temperature data, and ambient wind speed forecast data for the electrolyzer unit 104. For example, the weather forecast data may indicate a weather forecast in an area where the renewable power source is positioned during an upcoming time period and power generation forecast data may relate to a forecast of power that may be generated by the renewable power source during the upcoming time period. Moreover, the ambient air temperature data and ambient wind speed forecast data may relate to the conditions of air surrounding the electrolyzer unit 104.

Further, the ML model 108 may be applied on the received input data 106A to predict the operating load condition of the electrolyzer unit for the first time period of the set of time periods. Thereafter, the system 102 may be configured to determine the operating temperature range for the electrolyzer unit 104 for the first time period of the set of time periods based on the predicted operating load condition of the electrolyzer unit for the first time period.

Thereafter, the system 102 may be configured to determine the flow rate of the coolant from the cooling unit 104A to the electrolyzer unit 104 based on the determined operating temperature range for the electrolyzer unit 104 and the predicted operating load condition for the first time period. Further, the system 102 may be configured to control the cooling unit 104A to modify the flow rate of the coolant from the cooling unit 104A to the electrolyzer unit 104 based on the determined flow rate of the coolant to maintain the determined operating temperature range of the electrolyzer unit 104 for the predicted operating load condition.

The present disclosure is based on an understanding that due to intermittent nature of renewable energy-based power source, the electrolyzer unit 104 may be exposed to power availability corresponding to the part load condition, i.e., when power supplied to the electrolyzer unit 104 is less than a demand power at its rated hydrogen production; the full load condition, i.e., when power supplied to the electrolyzer unit 104 is equal to the demand power at its rated hydrogen production, or the overload condition, i.e., when power supplied to the electrolyzer unit 104 is greater than the demand power at its rated hydrogen production. To this end, when the electrolyzer unit 104 may be operated under the part load condition, heat generation within the electrolyzer unit 104 reduces.

However, in such cases, the heat removal from the electrolyzer unit 104 due to, for example, natural convection to ambient air or cooling fluid, does not reduce. Due to the reduction in heat generation and subsequent reduction in the operating temperature value of the electrolyzer unit 104 during such a part load condition, the performance and efficiency of the electrolyzer unit 104 may be reduced. Hence, it is important to control operating conditions, specifically, maintain the operating temperature value of the electrolyzer unit 104 during the part load condition.

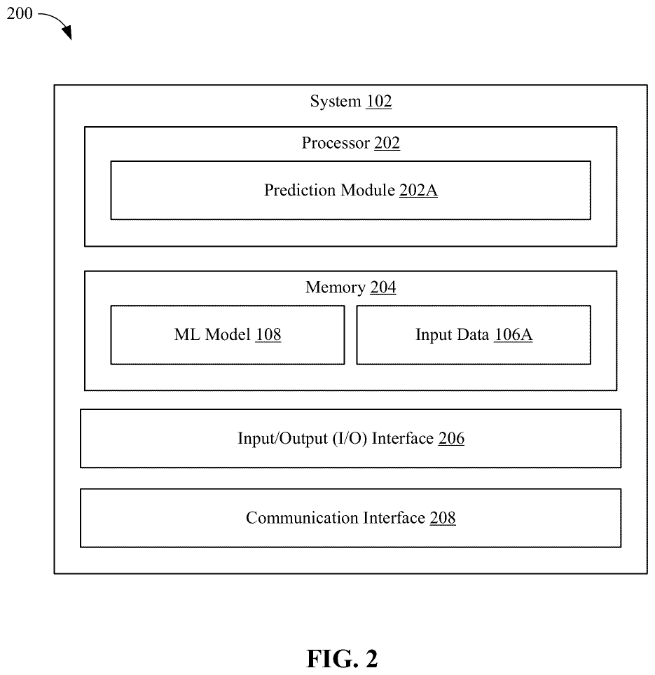

FIG. 2 illustrates a block diagram 200 of the apparatus of FIG. 1, in accordance with an embodiment of the disclosure. FIG. 2 is explained in conjunction with FIG. 1. In FIG. 2, there is shown the block diagram 200 of the system 102. The system 102 may include at least one processor 202 (referred to as a processor 202, hereinafter), at least one non-transitory memory 204 (referred to as a memory 204, hereinafter), an Input/Output (I/O) interface 206, and a communication interface 208. The processor 202 may comprise modules, depicted as, a prediction module 202A. The system 102 may be connected to the memory 204, and the I/O interface 206 through wired or wireless connections. Although in FIG. 2, it is shown that the system 102 includes the processor 202, the memory 204, and the I/O interface 206 however, the disclosure may not be so limiting and the system 102 may include fewer or more components to perform the same or other functions of the system 102. In some embodiments, the input data 106A (such as user inputs), and the output processed data (such as the predicted operating load condition, and the like) may be transmitted via the I/O interface 206.

In accordance with an embodiment, the system 102 may store data that may be generated by the modules while performing corresponding operations or may be retrieved from one or more databases 106 associated with the system 102, in the memory 204. For example, the input data 106A may include weather forecast information, power generation forecast information, ambient air temperature value information, and ambient wind speed forecast information.

The processor 202 may be configured to predict the operating load condition of the electrolyzer unit 104 and determine the operating temperature range for the electrolyzer unit 104 based on the predicted operating load condition. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment 100 may be accessed using the communication interface 208 of the system 102. The communication interface 208 may provide an interface for accessing various features and data stored in the system 102.

In some embodiments, the processor 202 may be configured to provide Internet-of-Things (IoT) related capabilities to users of the system 102 disclosed herein. The IoT-related capabilities may in turn be used to provide smart city solutions by providing first recommendation, real-time warnings, big data analysis, and sensor-based data collection by using the cloud-based mapping system for providing accurate navigation instructions and ensuring driver safety. The I/O interface 206 may provide an interface for accessing various features and data stored in the system 102.

The prediction module 202A of the processor 202 may be configured to apply the ML model 108 on the input data 106A. The input data 106A may be associated with at least one of the weather forecast data, power generation forecast data, ambient air temperature value data, and ambient wind speed forecast data. In an embodiment, the processor 202 may be configured to receive the input data 106A from the one or more databases 106. In an embodiment, the ML model 108 may be trained to predict the operating load condition based on the received input data 106A.

The memory 204 may be non-transitory and may include, for example, one or more volatile and/or non-volatile memories. In other words, for example, the memory 204 may be an electronic storage device (for example, a computer-readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. For example, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA, or the like, the processor 202 may be specifically configured hardware for conducting the operations described herein. In an embodiment, the memory 204 may be configured to store the ML model 108, and the input data 106A. For example, the memory 204 may be configured to store the weather forecast data, power generation forecast data, ambient air data value data, ambient wind speed forecast data, empirical heat loss data, and empirical heat generation data

In some example embodiments, the I/O interface 206 may communicate with the system 102 and display the input and/or output of the system 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, the system 102 may include a user interface circuitry configured to control at least some functions of one or more I/O interface elements such as a display and, in some embodiments, a plurality of speakers, a ringer, one or more microphones and/or the like. The I/O interface 206 may include circuitry and/or software that may be configured to provide an output, such as generating control signals for controlling the operating load conditions of the electrolyzer unit 104, and receiving, measuring, or sensing the input data 106A. The processor 202 and/or I/O interface 206 circuitry comprising the processor 202 may be configured to control one or more functions of one or more I/O interface 206 elements through computer program instructions (for example, software and/or firmware) stored on a memory 204 accessible to the processor 202. The processor 202 may further render notifications associated with the electrolyzer unit 104, such as the weather forecast, the power generation forecast, the ambient air temperature value, the ambient wind speed forecast, the empirical heat loss, and the empirical heat generation, etc., on the user equipment or audio or display onboard the electrolyzer unit 104 via the I/O interface 206.

The communication interface 208 may comprise an input interface and output interface for supporting communications to and from the system 102 or any other component with which the system 102 may communicate. The communication interface 208 may be any means such as a device or circuitry embodied in either hardware or a combination of hardware and software that is configured to receive and/or transmit data to/from a communications device in communication with the system 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms. In some embodiments, the communication interface 208 may enable communication with a cloud-based network to enable deep learning, such as using the ML model 108 (that may be hosted on the cloud-based network).

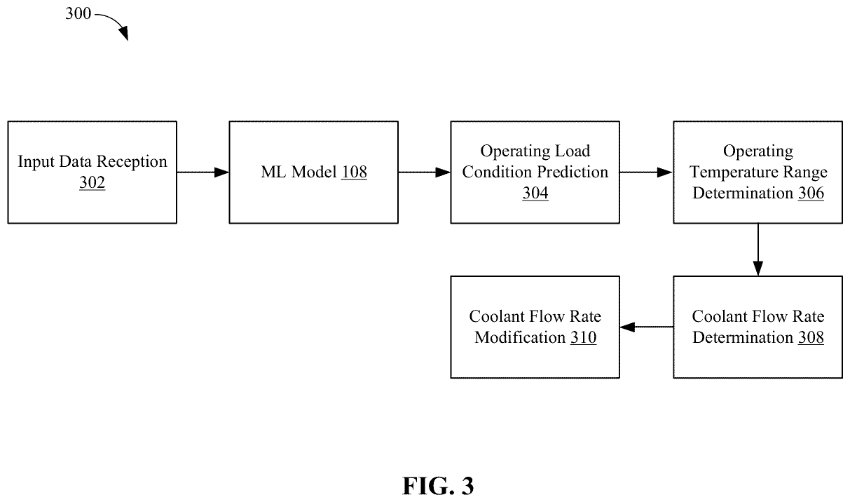

FIG. 3 is a block diagram 300 that illustrates an exemplary first set of operations for controlling the operating conditions for the electrolyzer unit 104, in accordance with an embodiment of the present disclosure. FIG. 3 is explained in conjunction with elements from FIG. 1 and FIG. 2. With reference to FIG. 3, there is shown the block diagram 300 that illustrates exemplary operations from 302 to 310, as described herein. The exemplary operations illustrated in the block diagram 300 may start at 302 and may be performed by any computing system, or device, such as by the system 102 of FIG. 1 or the processor 202 of FIG. 2. Although illustrated with discrete blocks, the exemplary operations associated with one or more blocks of the block diagram 300 may be divided into additional blocks, combined into fewer blocks, or eliminated, depending on the particular implementation.

In an embodiment, the flow rate of the coolant may be controlled for the electrolyzer unit 104 based on the predicted operating load conditions. The exemplary operations from 302 to 310 may be executed as soon as the input data 106A may be received. In another embodiment, the exemplary operations from 302 to 310 may be executed based on a reception of input indicative of the input data 106A via an input device (for example, such as a button that may be installed on the electrolyzer unit 104).

At 302, the input data 106A may be received. In an embodiment, the processor 202 may be configured to receive the input data 106A associated with the electrolyzer unit 104 from the one or more databases 106. For example, the input data 106A may be stored in the one or more databases 106. In operation, the processor 202 may be configured to receive input data 106A relating to environmental conditions and ambient temperature value of the electrolyzer unit 104. For example, the input data 106A may include, but is not limited to, weather forecast data, power generation forecast data, ambient air temperature value data, and ambient wind speed forecast data.

For example, the weather forecast data may include a short-term weather forecast of an area where the electrolyzer unit 104 may be deployed or the renewable energy-based power source (referred to as renewable power source, hereinafter) may be deployed. The short-term weather forecast may provide weather predictions for the next, for example, 30 minutes, 1 hour, 8 hours, 16 hours, 24 hours, 36 hours, etc. As may be noted, the weather forecast data may provide information relating to predictions on how environmental conditions or atmospheric conditions in an area may change. To this end, the weather forecast data may indicate, for example, the prediction of sunshine amount that may be experienced by an area where a solar-based power source may be positioned, and/or the prediction of how much windspeed may be experienced by an area where a wind-based power source may be positioned.

Further, the power generation forecast data may indicate how much power may be generated by the renewable power source over an upcoming period of time. In one example, the system 102 may be configured to generate the power generation forecast data based on the weather forecast data relating to an area where the renewable power source is present or deployed. For example, weather forecast data may indicate desired windspeed or sunshine, and power generation forecast data may indicate desired power output from wind-based or solar-based, respectively, renewable power sources. In another example, the weather forecast data may indicate low windspeed or partial sunshine, and the power generation forecast data may indicate that power output from wind-based or solar-based, respectively, renewable power sources may be less than the desired power output. It may be noted that the weather forecast data and the power generation forecast data may indicate prediction or forecast of weather and power, respectively, during the upcoming or future time period.

Further, the ambient air temperature value data may indicate wind temperature value near the electrolyzer unit 104, and ambient wind speed forecast data may indicate wind speed near the electrolyzer unit 104. It may be noted that a reduction in the operating temperature value of the electrolyzer unit 104 may occur due to the convection of the heat from the electrolyzer unit 104 into the ambient air surrounding the electrolyzer unit 104. To this end, the temperature value of the ambient air and the wind speed of the ambient air may affect the rate of reduction of the operating temperature value. For example, if the temperature value of the ambient air is low and/or the wind speed of the ambient air is high, then the rate of reduction of the operating temperature value due to convection may be high.

Furthermore, based on the weather forecast data, the power generation forecast data, the ambient air temperature value data, and the ambient wind speed forecast data, the system 102 may be configured to determine empirical heat loss information, and empirical heat generation information using the ML model 108. In an example, the ML and reduced-order physics-based model may estimate the empirical heat loss information, and empirical heat generation information based on the input data 106A. The empirical heat loss information may indicate a rate of heat loss or a rate of reduction in the operating temperature value of the electrolyzer unit 104 due to the convection of heat into the ambient air. For example, the empirical heat loss information may indicate the rate of heat loss based on the ambient air temperature value and the ambient wind speed forecast information. Moreover, the empirical heat generation information may indicate a rate of heating or a rate of increase in the operating temperature value of the electrolyzer unit 104 due to changes in the operating load condition (i.e., the part load condition, the full load condition, or the overload condition) or change (or increase) in the power supply of the electrolyzer unit 104. For example, the empirical heat generation data may indicate the rate of heating based on at least one of the weather forecast data, power generation forecast data, ambient air temperature data, and ambient wind speed forecast data. The empirical heat generation data may be based on the efficiency of the electrolyzer unit 104, the specified heat of a material, and the like. Further, the empirical heat generation data may indicate a heat balance equal to a difference between heat generation and heat loss due to the convection of heat into the ambient air and heat loss due to the cooling system.

At 304, an operating load condition may be predicted. In an embodiment, the processor 202 may be configured to predict the operating load condition of the electrolyzer unit 104 for the first time period of a set of time periods. In an embodiment, the processor 202 may be configured to apply the ML model 108 on the received input data 106A. Based on the application of the ML model 108 on the received input data 106A, the processor 202 may be configured to predict the operating load condition of the electrolyzer unit 104 for the first time period of the set of time periods. For example, the operating load condition may correspond to one of the part load condition, a full load condition, or an overload condition for the electrolyzer unit 104.

In an embodiment, the processor 202 may be configured to apply the ML model 108 on the received input data 106A at the first time period (say T1). Based on the application of the ML model 108 on the input data 106A, the processor 202 may be configured to predict the operating load condition of the electrolyzer unit 104 at a second time period (say T2). For example, the first time period T1, and the second time period T2 may be sections or parts of the set of time periods (such as the upcoming time periods). For example, across the first time period T1 and the second time period T2, weather forecast data, and power generation data, for the renewable power sources may be expected to change slightly or substantially. The ML model 108 may be applied on the input data 106A at the first time period (T1) to predict the operating load condition for the electrolyzer unit 104 at the second time period (T2). For example, the system 102 may leverage the ML model 108 to predict whether the electrolyzer unit 104 may experience the part load condition, the full load condition, or the overload condition in each of the first time period and the second time period. For example, the ML model 108 may estimate the operating load conditions across the second time period based on the forecast of environmental conditions of the renewable power source or the forecast of power generated by the renewable power source, such as the weather forecast data and power generation forecast data.

In an example, the processor 202 may be further configured to determine the first time period of the set of time periods based on at least a pre-defined time duration or a change in weather conditions. For example, the first time period and the second time period may be determined based on time durations, such as 10 minutes, 30 minutes, 1 hour, etc. In another example, the first time period and the second time period may be determined based on a level of change in weather conditions for the renewable power source or a change in the operating load condition of the electrolyzer unit 104. For example, during the first time period, the electrolyzer unit 104 may operate at full load, i.e., the weather conditions for the renewable power source may be desirable or ideal. Further, during the second time period, the electrolyzer unit 104 may operate at the part load condition, i.e., the weather conditions for the renewable power source may not be desirable or ideal, for example, due to cloudy weather conditions (for solar power source), or low wind speed (for wind power source).

At 306, an operating temperature range may be determined. In an embodiment, the processor 202 may be configured to determine the operating temperature range for the electrolyzer unit 104 for the first time period of the set of time periods based on the predicted operating load condition of the electrolyzer unit 104 for the first time period. Further, the operating temperature range may be indicative of a temperature range associated with the operating load condition for the electrolyzer unit 104. For example, when the input data 106A may be received at the first time period, the processor 202 may be configured to predict the operating load condition of the electrolyzer unit 104 for at least the subsequent time periods, such as the second time period. For example, the full load condition may be predicted by the ML model 108 for the second time period (T2). The processor 202 may be configured to determine the operating temperature values that the electrolyzer unit 104 during the full load condition.

Further, the ML model 108 may predict the operating load condition that may be experienced by the electrolyzer unit 104 in different time periods based on the changing operating load conditions of the electrolyzer unit 104 as well as heat loss due to ambient air temperature value and ambient wind speed surrounding the electrolyzer unit 104. For example, while the changing operating load conditions may indicate changes in the power supply of the electrolyzer unit 104, it may not be sufficient to estimate changes in the operating temperature value of the electrolyzer unit 104. To this end, a rate of change of operating temperature value, i.e., how fast or how much heat may be converted from the electrolyzer unit 104 to the ambient air when power supply may be reduced (such as in the part load condition) as well as how fast or how much heat may be converted from the electrolyzer unit 104 to the ambient air when optimum power supply may be received (such as in the full load condition or the overload condition), may be considered to estimate change in the operating temperature value of the electrolyzer unit 104.

For example, during the first time period (say T1) when full load condition or overload operating condition may be experienced, i.e., the power supply to the electrolyzer unit 104 may be optimal, and the operating temperature value of the electrolyzer unit 104 may be within the operating temperature range. However, during the second time period (say T2) when the part load operating load condition may be experienced, i.e., power supply to the electrolyzer unit 104 may be less than desired power, and the operating temperature value of the electrolyzer unit 104 may reduce, for example, may fall below the operating temperature range. Moreover, the rate of change (or rate of reduction) of the operating temperature value between the first time period (T1) and the second time period (T2) may be estimated based on the ambient air temperature value, the ambient wind speed, the empirical heat loss information, and the empirical heat generation information.

Further, based on the predicted operating load conditions and the determined operating temperature range of the electrolyzer unit 104, the processor 202 may be configured to control the operating load condition of the electrolyzer unit 104 in each of the set of time periods (such as the first time period (T1) and the second time period (T2)). For example, the ML model 108 may predict operating temperature value based on a current operating load condition (such as at the first time period T1) and a subsequent operating load condition (such as at the second time period T2). This may facilitate the efficient operation of the electrolyzer unit 104 in real-time as well as in upcoming time periods.

In particular, the processor 202 may be configured to control an actual operating temperature value of the electrolyzer unit 104 across the set of time periods. In this regard, the ML model 108 may estimate different operating load conditions that may be experienced by the electrolyzer unit 104. Further, the processor 202 may leverage the use of such estimation by the ML model 108 to modify a manner in which the operating temperature values of the electrolyzer unit 104, thereby owing to changes in weather conditions of the renewable power source and conditions of ambient air around the electrolyzer unit 104. Based on this information, the ML model 108 may estimate a manner in which the operating load condition of the electrolyzer unit 104 may be controlled such that the electrolyzer unit 104 operates within the operating temperature range across different operating load conditions (such as the part load, the full load, and the overload conditions).

In an example, the ML model 108 may predict a high operating temperature value for the electrolyzer unit 104 for the present time period based on a prediction of an upcoming part load condition in a subsequent time period. To this end, the system 102 may control the operating load condition of the electrolyzer unit 104 such that the cooling system for heat removal may be reduced and/or stopped to the electrolyzer unit 104 during the present time period to heat the electrolyzer to the high operating temperature value. Further, when the subsequent time period comes (i.e., the subsequent time period becomes the present time period) and the actual operating load of the electrolyzer unit 104 may reduce to the part load operating load condition, then the actual operating temperature value of the electrolyzer unit 104 may also start to reduce due to convection and cooling fluid. However, as the electrolyzer unit 104 may heat up to the high operating temperature value in the previous time period, therefore, even after the heat loss due to convection and cooling fluid, the actual operating temperature value may lie within the operating temperature range. In this manner, the efficiency of the electrolyzer unit 104 may be maintained during the time period when the part load condition may be experienced. Further, as the actual operating temperature value during the part load condition may be within the operating temperature range, and the next full load or overload condition comes, the efficiency of the electrolyzer unit 104 may be maintained even when the actual operating temperature value may only start to increase.

In an embodiment, the determined operating temperature range includes an upper temperature value and a lower temperature value. The upper temperature value corresponds to a maximum operating temperature value associated with the operating load condition of the electrolyzer unit 104. Further, the lower temperature value corresponds to a minimum operating temperature value associated with the operating load condition of the electrolyzer unit 104. For example, the upper temperature value may be a maximum limit of the optimum operating temperature range, and the lower temperature value may be a minimum limit of the optimum operating temperature range. In an embodiment, the processor 202 may be configured to receive the upper temperature value and the lower temperature value associated with the determined operating temperature range for the operating load condition and store them in the memory 204. For example, the upper temperature value and the lower temperature value may be determined based on material design and equipment design. The operating temperature range of the electrolyzer unit 104 may be defined based on the material and equipment design. In other words, the operating temperature range of the electrolyzer unit 104 may vary based on the material used in its components. For example, an alkaline electrolyzer may have an operating temperature range of between 60 degrees Celsius to 80 degrees Celsius. In another example, a proton exchange membrane electrolyzer may have an operating temperature range of between 50 degrees Celsius to 80 degrees Celsius, and an anion exchange electrolyzer may have an operating temperature range of between 40 degrees Celsius to 60 degrees Celsius. In another embodiment, the processor 202 may be configured to apply the ML model 108 on the received input data 106A to determine the upper temperature value and the lower temperature value associated with the determined operating temperature range for the corresponding operating load condition, the optimum operating temperature range may be pre-defined or estimated dynamically by the ML model 108. For example, the operating temperature range may be predicted based on how long the upcoming or subsequent part load condition would last or how far be next full load or overload condition, how much change (or reduction) in the operating temperature value may be seen over the part load condition, and temperature value specifications of the electrolyzer unit 104. For example, the operating temperature range may also be predicted such that when the electrolyzer unit 104 is heated up to the upper limit before the part load operating load condition, then the electrolyzer unit 104 may reach only till a lower limit of the optimum operating temperature range to ensure the efficiency of the electrolyzer unit 104 during the part load operating load condition. For example, the optimum operating temperature range for the electrolyzer unit 104 may be in a range of 70° C. to 80° C. Therefore, the lower temperature value may be 70° C. while the upper temperature value may be 80° C. In another example, the operating temperature range for the electrolyzer unit 104 may be in a range of 70° C. to 100° C. Therefore, the lower temperature value may be 70° C. while the upper temperature value may be 100° C.

At 308, the flow rate of a coolant may be determined. In an embodiment, the processor 202 may be configured to determine the flow rate of the coolant from the cooling unit 104A of the electrolyzer unit 104 based on the determined operating temperature range of the electrolyzer unit 104 and the predicted operating load condition for the first time period. Further, the coolant may be a cooling liquid (such as water, antifreeze, or the like), or a gas (such as air, hydrogen, or the like) that may be responsible for reducing or regulating the temperature value. The coolant may have a pre-defined thermal capacity, viscosity, cost, chemical inertness, and electrical insulation. Further, one or more control valves may be adjusted to regulate the flow rate of the coolant based on the determined operating temperature range of the electrolyzer unit 104 and the predicted operating load condition for the first time period.

At 310, a coolant flow may be modified. In an embodiment, the processor 202 may be configured to control the cooling unit 104A to modify the flow rate of the coolant from the cooling unit 104A to the electrolyzer unit 104 to maintain the determined operating temperature range of the electrolyzer unit 104 for the predicted operating load condition. For example, the determined flow rate of the coolant may be one of an increased flow rate of the coolant, a decreased flow rate of the coolant, and a stagnant flow rate of the coolant. For example, in operation, the flow of the coolant may correspond to a value ‘X’ for a current time period. In such a scenario, the flow of the coolant may correspond to a value greater than ‘X’ to indicate the increased flow of the coolant for the predicted overload condition when the temperature value may be increased inside the electrolyzer unit 104 to maintain the operating temperature value. In another example, the flow of the coolant may correspond to a value smaller than ‘X’ to indicate the flow rate of the coolant may be decreased when the temperature value is decreased inside the electrolyzer unit 104 to maintain the operating temperature value. In yet another example, the flow of the coolant may correspond to the value ‘X’ to indicate the flow rate of the coolant may remain the same when the temperature value is stagnant inside the electrolyzer unit 104 to maintain the operating temperature value.

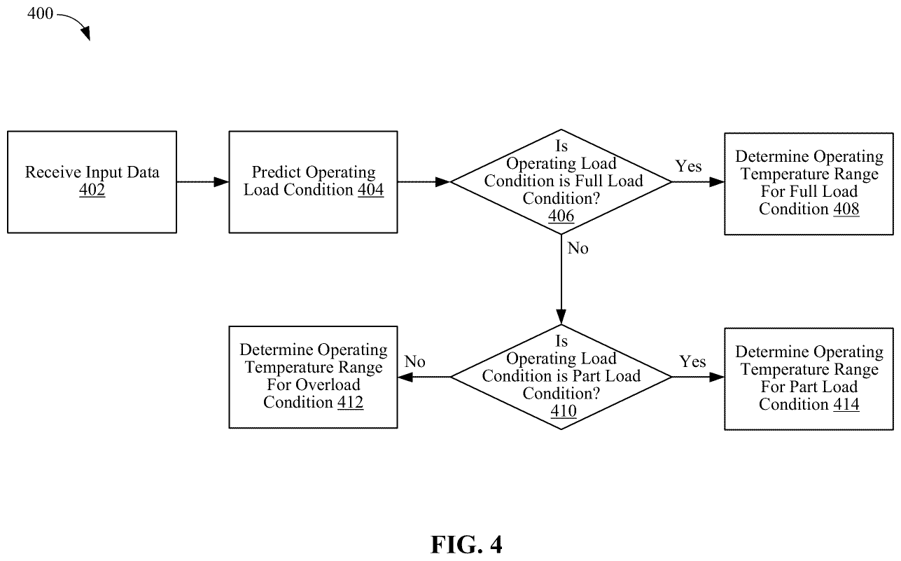

FIG. 4 is a block diagram 400 that illustrates an exemplary second set of operations for controlling operating conditions of the electrolyzer unit 104, in accordance with an embodiment of the present disclosure. FIG. 4 is explained in conjunction with elements from FIG. 1, FIG. 2, and FIG. 3. With reference to FIG. 4, there is shown the block diagram 400 that illustrates exemplary operations from 402 to 414, as described herein. The exemplary operations illustrated in the block diagram 400 may start at 402 and may be performed by any computing system, apparatus, or device, such as by the system 102 of FIG. 1 or the processor 202 of FIG. 2. Although illustrated with discrete blocks, the exemplary operations associated with one or more blocks of the block diagram 400 may be divided into additional blocks, combined into fewer blocks, or eliminated, depending on the particular implementation.

In an embodiment, the operating load condition may be predicted for the electrolyzer unit 104. The exemplary operations from 402 to 414 may be executed as soon as the input data 106A may be received. In another embodiment, the exemplary operations from 402 to 414 may be executed based on the input data 106A acquisition via an input device (say via a button installed on the electrolyzer unit 104).

At 402, input data 106A may be received. In an embodiment, the system 102 may be configured to receive the input data 106A associated with the electrolyzer unit 104 from the one or more databases 106, as described for example, at 302 in FIG. 3.

At 404, an operating load condition may be predicted. In an embodiment, the system 102 may be configured to predict the operating load condition associated with the electrolyzer unit 104 based on the input data 106A using the ML model 108, as described for example, at 304 in FIG. 3.

At 406, determine if the operating load condition is the full load condition. In an embodiment, the system 102 may be configured to determine whether the predicted operating load condition is the full load condition or not. In an exemplary embodiment, if the condition may be the full load condition, the processor 202 may be configured to determine the operating temperature range for the full load condition using the ML model 108, as described for example, at 306 in FIG. 3. For example, if the predicted operating load condition is the full load condition, the control may pass to 408. On the contrary, if the predicted operating load condition is not the full load condition, the control may pass to 410.

At 408, an operating temperature range may be determined for the full load condition. In an embodiment, the system 102 may be configured to determine the operating temperature range associated with the full load condition for the electrolyzer unit 104. In an exemplary embodiment, if the condition may be the full load condition, the processor 202 may be configured to determine the operating temperature range for the full load condition.

At 410, determine if the operating load condition is the part load condition. In an embodiment, the system 102 may be configured to determine whether the predicted operating load condition is the part load condition or not. In an exemplary embodiment, if the condition may be the part load condition, the processor 202 may be configured to determine the operating temperature range for the part load condition using the ML model 108, as described for example, at 306 in FIG. 3. For example, if the predicted operating load condition is the part load condition, the control may pass to 414. On the contrary, if the predicted operating load condition is not the part load condition, the control may pass to 412.

At 412, an operating temperature range may be determined for the overload condition. In an embodiment, the system 102 may be configured to determine the operating temperature range associated with the overload condition for the electrolyzer unit 104. In an exemplary embodiment, the processor 202 may be configured to determine the operating temperature range for the overload condition.

At 414, an operating temperature range may be determined for the part load condition may be executed. In an embodiment, the system 102 may be configured to determine the operating temperature range associated with the part load condition for the electrolyzer unit 104. In an exemplary embodiment, the processor 202 may be configured to determine the operating temperature range for the part load condition.

Upon determination of the operating temperature range for the corresponding operating load condition, the processor 202 may be configured to determine the flow rate of the coolant from the cooling unit 104A of the electrolyzer unit 104 based on the determined operating temperature range of the electrolyzer unit 104 and the predicted operating load condition for the first time period, as described, for example, at 308 in FIG. 3. Thereafter, the processor 202 may be configured to control the cooling unit 104A to modify the flow rate of the coolant from the cooling unit 104A to the electrolyzer unit 104 to maintain the determined operating temperature range of the electrolyzer unit 104 for the predicted operating load condition, as described, for example, at 310 in FIG. 3.

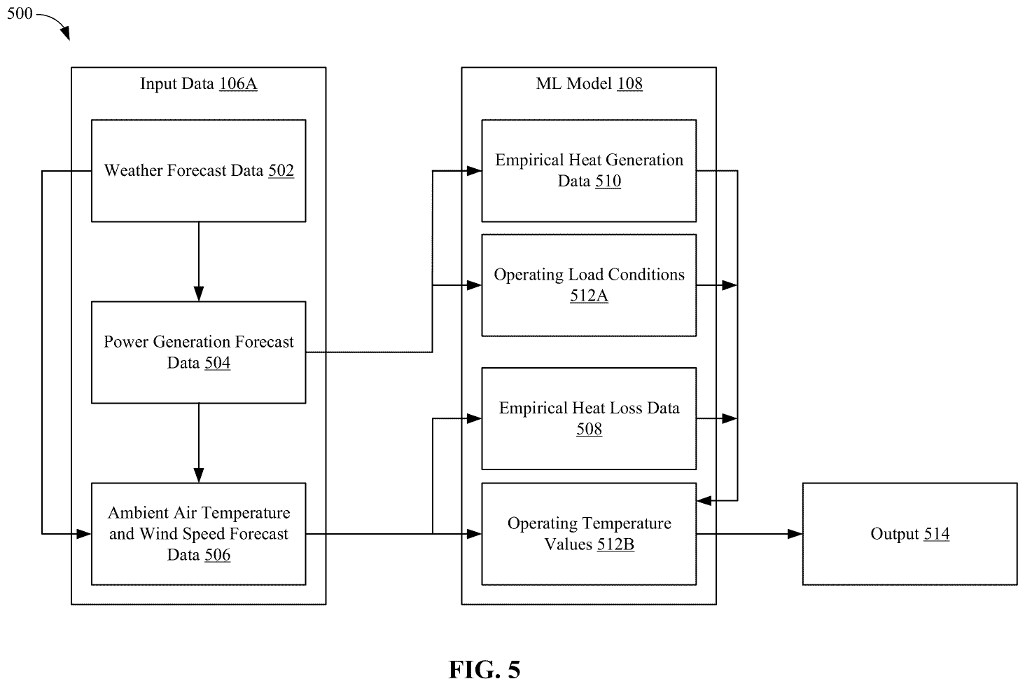

FIG. 5 illustrates a schematic diagram 500 for performing predictions relating to the electrolyzer unit 104 using the ML model 108, in accordance with an example embodiment of the present disclosure. FIG. 5 is explained in conjunction with elements of FIG. 1, FIG. 2, FIG. 3, FIG. 4. The ML model 108 may be embodied to be a part of the system 102 or may be communicatively coupled to the system 102 for controlling the operating condition of the electrolyzer unit 104.

In an example, the ML model 108 may be trained to make predictions or estimations regarding how much the electrolyzer temperature value may be allowed to rise such that heat loss during part load conditions is accounted for and the efficiency of the electrolyzer unit 104 may be ensured. For example, the ML model 108 may be trained using a supervised machine learning technique, an unsupervised machine learning technique, a reinforcement machine learning technique, etc.

The input data 106A may refer to information, values, or content that may be provided to the ML model 108 to perform a task, make a decision, or generate an output 514. The input data 106A may include, but is not limited to, weather forecast data 502, power generation forecast data 504, ambient air temperature value and ambient wind speed forecast data 506.

The weather forecast data 502 may provide predictions about upcoming atmospheric conditions, including temperature value, precipitation, wind, speed, humidity, and more. For example, the weather forecast data 502 may be generated through an analysis of various meteorological data sources, such as satellite imagery, weather stations, and computer models. Further, the power generation forecast data 504 may indicate information relating to the generation of power from renewable sources such as solar plants and wind turbines, based on the weather forecast data 502. This generated power may be further supplied to the electrolyzer unit 104 for operations associated therewith. As weather conditions like sunlight, wind speed, and temperature value impact renewable power sources, such as solar panels and wind turbines, the ML model 108 may be configured to estimate the power generation forecast data 504 or potential power outputs from the renewable power source based on the weather conditions included in the weather forecast data 502. For example, the power generation forecast data 504 may be predicted for each of the plurality of time periods, based on the weather forecast data 502 in each of the plurality of time periods.

The ambient air temperature value and ambient wind speed forecast data 506 may indicate information relating to the temperature value of ambient air and ambient wind speed around the electrolyzer unit 104. In some embodiments, the ML model 108 may perform an analysis of the weather forecast data 502 to generate the ambient air temperature value and ambient wind speed forecast data 506. In an example, the ambient air temperature value and ambient wind speed forecast data 506 may be generated for each of the plurality of time periods.

Further, the ML model 108 may estimate empirical heat loss data 508, and empirical heat generation data 510 based on the received input 106A. The empirical heat loss data 508 may indicate information relating to the rate of heat loss around the electrolyzer unit 104 due to the convection of heat. In some embodiments, the ML model 108 may analyze the empirical heat loss data 508 using relevant formulas, and correlations between these two factors such as heat loss and the ambient air temperature value and ambient wind speed. For example, the ML model 108 may use regression analysis techniques to create empirical equations that may represent a relationship between ambient conditions and heat loss. These empirical equations may be further used to estimate the operating load condition of the electrolyzer unit 104.

The empirical heat generation data 510 may indicate information relating to the rate of heat generation in the electrolyzer unit 104 based on the power supply and degradation of an electrolyzer stack. In some embodiments, the ML model 108 may analyze the heat generation using relevant formulas, and correlations between these two factors such as heat generation and power supply, wherein in general, if the power supply is high, then heat generation may also be high. Similarly, if power supply is low, then heat generation will also be low. For example, the ML model 108 may use regression analysis techniques to create empirical equations that may represent a relationship between ambient conditions, power generation, and heat generation.

In an operation, the ML model 108 may be configured to estimate the operating load conditions 512A of the electrolyzer unit 104 during the second time period based on the power generation forecast data 504. As described in FIG. 1, the operating load conditions 512A may indicate whether the electrolyzer unit 104 would experience the part load, the full load, or the overload conditions in the second time period based on the power supply to the electrolyzer unit 104.

Further, the ML model 108 is configured to estimate the operating temperature values 512B of the electrolyzer unit 104 during the second time period based on the estimated operating load conditions 512A and the input data 106A. In this regard, the operating temperature value 512B may indicate changes in the operating temperature value of the electrolyzer unit 104 based on varying operating load conditions of the electrolyzer unit 104 as well as rate of heat generation, and rate of heat loss. Based on the predicted operating load conditions 512A and the estimated operating temperature values 512B, the ML model 108 may predict a manner of control of operating conditions of the electrolyzer unit 104. The estimated manner of control may be provided via the output 514.

For example, the set of time periods may include, but is not limited to, the first time period, the second time period, a third time period, and a fourth time period. The first time period, the second time period, the third time period, and the fourth time period may correspond to subsequent time periods. For example, the operating load condition for the first time period may be the full load or overload condition, i.e., the power supply for the electrolyzer unit 104 may be equal to or greater than the demand. Further, the predicted operating load condition for the second time period may be part load, i.e., the power supply for the electrolyzer unit 104 may be less than demand. In such a case, the ML model 108 may predict that the predicted operating temperature value for the electrolyzer unit 104 during the second time period may be less than a lower limit of the optimum operating temperature range due to the part load. To this end, to ensure the efficiency of the electrolyzer unit 104 during the second time period, i.e., part load condition, the ML model 108 may predict a manner of control of the operating condition of the electrolyzer unit 104 such that the operating temperature value of the electrolyzer unit 104 may be allowed to increase to a high operating temperature value in the first time period. In particular, the operating temperature value of the electrolyzer unit 104 may be allowed to reach an upper limit of the operating temperature range in order to maintain an actual operating temperature value of the electrolyzer within the operating temperature range during the second time period.

For example, the operating load condition for the third time period may be the full load or overload, and the predicted operating load condition for the fourth time period may also be the full load or overload. In such a case, the ML model 108 predicts the predicted operating temperature value for the electrolyzer unit 104 during the third time period may be greater than or equal to the upper limit of the optimum operating temperature range due to the overload or full load, as well as an estimated operating temperature value for the electrolyzer during the fourth time period may also be greater than or equal to the upper limit of the optimum operating temperature range due to the overload or full load. To this end, to ensure the efficiency of the electrolyzer unit 104 during the fourth time period, i.e., to prevent any damage due to overheating, the ML model 108 may predict the operating condition of the electrolyzer unit 104 such that the operating temperature value of the electrolyzer unit 104 in the third time period may be allowed to reach close to the lower limit of the operating temperature range in order to maintain an actual operating temperature value of the electrolyzer within the operating temperature range during the fourth time period.

For example, an amount of cooling fluid flowing in the electrolyzer unit 104 may be regulated to bring the operating temperature value down in case of continuous overload or full load conditions. Moreover, in cases of prediction of upcoming part load conditions, the flow of cooling fluid may be reduced or made stagnant to ensure heating of the electrolyzer unit 104 to higher temperature values.

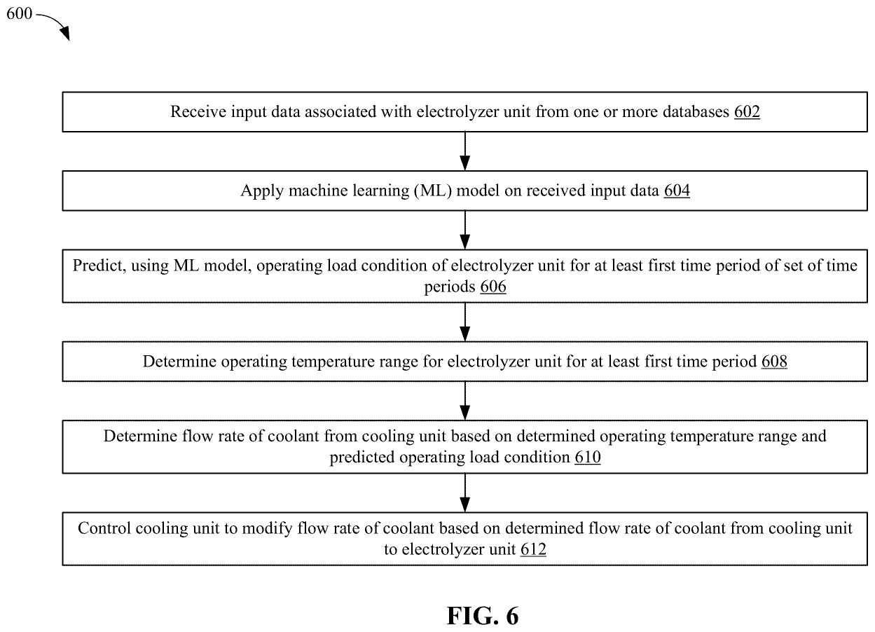

FIG. 6 is a flowchart 600 that illustrates an exemplary method for controlling the operating conditions of the electrolyzer unit 104, in accordance with an embodiment of the disclosure. FIG. 6 is explained in conjunction with elements from FIG. 1, FIG. 2, FIG. 3, FIG. 4, and FIG. 5. With reference to FIG. 6, there is shown the flowchart 600. The operations of the exemplary method may be executed by any computing system, for example, by the system 102 of FIG. 1 or the processor 202 of FIG. 2. The operations of the flowchart 600 may start at 602.

At 602, the input data 106A associated with an electrolyzer unit 104 may be received from one or more databases 106. In an embodiment, the system 102 may be configured to receive the input data 106A associated with the electrolyzer unit 104 from the one or more databases 106. In another embodiment, the processor 202 may be configured to receive the input data 106A associated with the electrolyzer unit 104 from the one or more databases 106. Details associated with the reception of the input data 106A are provided, for example, in FIG. 3.

At 604, the ML model 108 may be applied on the received input data 106A. In an embodiment, the system 102 may be configured to apply the ML model 108 on the received input data 106A. In another embodiment, the processor 202 may be configured to apply the ML model 108 on the received input data 106A. Details associated with the ML model 108 are provided, for example, in FIG. 1 and FIG. 3.

At 606, an operating load condition may be predicted for the electrolyzer unit 104 for the first time period of a set of time periods. In an embodiment, the system 102 may be configured to predict, based on the application of the ML model 108 on the received input data 106A, the operating load condition of the electrolyzer unit 104 for the first time period of the set of time periods. In an embodiment, the processor 202 may be configured to predict, based on the application of the ML model 108 on the received input data 106A, the operating load condition of the electrolyzer unit 104 for the first time period of the set of time periods. Details associated with the prediction of the operating load condition are provided, for example, in FIG. 3.

At 608, an operating temperature range of the electrolyzer unit 104 may be determined based on the predicted operating load condition of the electrolyzer unit 104 for the first time period. In an embodiment, the system 102 may be configured to determine the operating temperature range of the electrolyzer unit 104 based on the predicted operating load condition of the electrolyzer unit 104 for the first time period. In an embodiment, the processor 202 may be configured to determine the operating temperature range of the electrolyzer unit 104 based on the predicted operating load condition of the electrolyzer unit 104 for the first time period. Details associated with the determination of the operating temperature range are provided for example, in FIG. 3 and FIG. 4.

At 610, the flow rate of the coolant may be determined from the cooling unit 104A to the electrolyzer unit 104 based on the determined operating temperature range of the electrolyzer unit 104 and the predicted operating load condition for the first time period. In an embodiment, the system 102 may be configured to determine the flow rate of the coolant from the cooling unit 104A to the electrolyzer unit 104 based on the determined operating temperature range of the electrolyzer unit 104 and the predicted operating load condition for the first time period. In an embodiment, the processor 202 may be configured to determine the flow rate of the coolant from the cooling unit 104A to the electrolyzer unit 104 based on the determined operating temperature range of the electrolyzer unit 104 and the predicted operating load condition for the first time period. Details associated with the determination of the flow rate of the coolant are provided, for example, in FIG. 3.

At 612, the cooling unit may be controlled to modify the flow rate of the coolant from the cooling unit 104A to the electrolyzer unit 104 based on the determined flow rate of the coolant. In an embodiment, the system 102 may be configured to control the cooling unit to modify the flow rate of the coolant from the cooling unit 104A to the electrolyzer unit 104 based on the determined flow rate of the coolant. In an embodiment, the processor 202 may be configured to control the cooling unit to modify the flow rate of the coolant from the cooling unit 104A to the electrolyzer unit 104 based on the determined flow rate of the coolant from the cooling unit to maintain the determined operating temperature range of the electrolyzer unit for the predicted operating load condition. Details associated with the modification of the flow rate of the coolant are provided, for example, in FIG. 3.

Accordingly, blocks of the flowchart 600 support combinations of means for performing the specified functions and combinations of operations for performing the specified functions. It will also be understood that one or more blocks of the flowchart 600, and combinations of blocks in the flowchart 600, can be implemented by special-purpose hardware-based computer systems which perform the specified functions, or combinations of special-purpose hardware and computer instructions.

Alternatively, the system 102 may include means for performing each of the operations described above. In this regard, according to an example embodiment, examples of means for performing operations may comprise, for example, the processor and/or a device or circuit for executing instructions or executing an algorithm for processing information as described above.

Various embodiments of the disclosure may provide a non-transitory computer-readable medium having stored thereon computer-executable instructions, which when executed by one or more processors (such as the processor 202), cause the one or more processors to carry out operations to operate a system (such as the system 102) for controlling operating condition of an electrolyzer. The instructions may cause the machine and/or computer to perform operations including receiving the input data 106A from one or more databases 106. The operations may include applying the machine learning (ML) model 108 on the received input data 105A. The operations may include predicting, based on the application of the ML model 108 on the received input data 106A, the operating load condition of the electrolyzer unit 104 for the first time period of the set of time periods. The operations may include determining the operating temperature range of the electrolyzer unit 104 based on the predicted operating load condition of the electrolyzer unit 104 for the first time period of the set of time periods. The operations may include determining the flow rate of the coolant from the cooling unit 104A to the electrolyzer unit 104 based on the determined operating temperature range of the electrolyzer unit 104 and the predicted operating load condition for the first time period. The operations may include controlling the cooling unit to modify the flow rate of the coolant from the cooling unit 104A to the electrolyzer unit 104 based on the determined flow rate of the coolant from the cooling unit to maintain the determined operating temperature range of the electrolyzer unit for the predicted operating load condition.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

What is claimed:

1. A system, comprising:
at least one non-transitory memory configured to store computer-executable instructions, and at least one processor configured to execute the computer-executable instructions to:
receive input data associated with an electrolyzer unit from one or more databases;
apply a machine learning (ML) model on the received input data;
predict, based on the application of the ML model on the received input data, an operating load condition of the electrolyzer unit for a first time period of a set of time periods;
determine an operating temperature range for the electrolyzer unit for the first time period of the set of time periods based on the predicted operating load condition of the electrolyzer unit for the first time period of the set of time periods;
determine a flow rate of a coolant from a cooling unit to the electrolyzer unit based on the determined operating temperature range for the electrolyzer unit and the predicted operating load condition of the electrolyzer unit for the first time period; and
control the cooling unit to modify the flow rate of the coolant from the cooling unit to the electrolyzer unit based on the determined flow rate of the coolant to maintain the determined operating temperature range of the electrolyzer unit for the predicted operating load condition.

2. The system of claim 1, wherein the received input data comprises at least one of: weather forecast data, power generation forecast data, ambient air temperature data, and ambient wind speed forecast data.

3. The system of claim 1, wherein the operating load condition of the electrolyzer unit for the first time period of the set of time periods corresponds to one of: a part load condition, a full load condition, or an overload condition.

4. The system of claim 1, wherein the processor is further configured to execute the computer-executable instructions to determine the first time period of the set of time periods based on at least: a pre-defined time duration or a change in weather conditions.

5. The system of claim 1, wherein the determined operating temperature range comprises an upper temperature value and a lower temperature value, and wherein the upper temperature value corresponds to a maximum operating temperature value associated with the operating load condition of the electrolyzer unit and the lower temperature value corresponds to a minimum operating temperature value associated with the operating load condition of the electrolyzer unit.

6. The system of claim 5, wherein the processor is further configured to execute the computer-executable instructions to:
receive the upper temperature value and the lower temperature value associated with the determined operating temperature range for the operating load condition; and
store the received upper temperature value and the lower temperature value.

7. The system of claim 5, wherein the processor is further configured to execute the computer-executable instructions to apply the ML model on the received input data to determine the upper temperature value and the lower temperature value associated with the determined operating temperature range for the corresponding operating load condition.

8. A method, comprising:
receiving input data associated with an electrolyzer unit from one or more databases;
applying a machine learning (ML) model on the received input data;
predicting, based on the application of the ML model on the received input data, an operating load condition of the electrolyzer unit for a first time period of a set of time periods;
determining an operating temperature range for the electrolyzer unit for the first time period of the set of time periods based on the predicted operating load condition of the electrolyzer unit for the first time period of the set of time periods;
determining a flow rate of a coolant from a cooling unit to the electrolyzer unit based on the determined operating temperature range for the electrolyzer unit and the predicted operating load condition of the electrolyzer unit for the first time period; and
controlling the cooling unit to modify the flow rate of the coolant from the cooling unit to the electrolyzer unit based on the determined flow rate of the coolant to maintain the determined operating temperature range of the electrolyzer unit for the predicted operating load condition.

9. The method of claim 8, wherein the received input data comprises at least one of weather forecast data, power generation forecast data, ambient air temperature data, and ambient wind speed forecast data.

10. The method of claim 8, wherein the operating load condition of the electrolyzer unit for the first time period of the set of time periods corresponds to one of: a part load condition, a full load condition, or an over load condition.

11. The method of claim 8, further comprising determining the first time period of the set of time periods based on at least: a pre-defined time duration or a change in weather conditions.

12. The method of claim 8, wherein the determined operating temperature range comprises an upper temperature value and a lower temperature value, and wherein the upper temperature value corresponds to a maximum operating temperature value associated with the operating load condition of the electrolyzer unit and the lower temperature value corresponds to a minimum operating temperature value associated with the operating load condition of the electrolyzer unit.

13. The method of claim 12, further comprising:
receiving the upper temperature value and the lower temperature value associated with the determined operating temperature range for the operating load condition; and
storing the received upper temperature value and the lower temperature value.

14. The method of claim 13, further comprising applying the ML model on the received input data to determine the upper temperature value and the lower temperature value associated with the determined operating temperature range for the corresponding operating load condition.

15. A non-transitory computer-readable medium having stored thereon, computer-executable instructions that when executed by a processor of a system, causes the processor to execute operations, the operations comprising:
receiving input data associated with an electrolyzer unit from one or more databases;
applying a machine learning (ML) model on the received input data;
predicting, based on the application of the ML model on the received input data, an operating load condition of the electrolyzer unit for a first time period of a set of time periods;
determining an operating temperature range for the electrolyzer unit for the first time period of the set of time periods based on the predicted operating load condition of the electrolyzer unit for the first time period of the set of time periods;
determining a flow rate of a coolant from a cooling unit to the electrolyzer unit based on the determined operating temperature range for the electrolyzer unit and the predicted operating load condition of the electrolyzer unit for the first time period; and
controlling the cooling unit to modify the flow rate of the coolant from the cooling unit to the electrolyzer unit based on the determined flow rate of the coolant to maintain the determined operating temperature range of the electrolyzer unit for the predicted operating load condition.

16. The non-transitory computer-readable medium of claim 15, wherein the received input data comprises at least one of weather forecast data, power generation forecast data, ambient air temperature data, and ambient wind speed forecast data.

17. The non-transitory computer-readable medium of claim 15, wherein the operating load condition of the electrolyzer unit for the first time period of the set of time periods corresponds to one of: a part load condition, a full load condition, or an over load condition.

18. The non-transitory computer-readable medium of claim 15, wherein the determined operating temperature range comprises of an upper temperature value and a lower temperature value, and wherein the upper temperature value corresponds to a maximum operating temperature value associated with the operating load condition of the electrolyzer unit and the lower temperature value corresponds to a minimum operating temperature value associated with the operating load condition of the electrolyzer unit.

19. The non-transitory computer-readable medium of claim 18, further comprising:
receiving the upper temperature value and the lower temperature value associated with the determined operating temperature range for the operating load condition; and
storing the received upper temperature value and the lower temperature value.

20. The non-transitory computer-readable medium of claim 18, further comprising applying the ML model on the received input data to determine the upper temperature value and the lower temperature value associated with the determined operating temperature range for the corresponding operating load condition.
